(19) United States
(12) Patent Application Publication
(10) Pub. No.: US 2026/0070563 A1
(43) Pub. Date: Mar. 12, 2026

(54) Computer-Implemented Method for Detecting a Change in the Driver's State with a Steer-by-Wire Steering System

(71) Applicant: Robert Bosch GmbH, Stuttgart (DE)

(72) Inventors: Philipp Scheffler, Heilbronn (DE); Florian Rochel, Schorndorf (DE); Florian Kling, Waldstetten (DE); Luis Augusto Huergo, Tuebingen (DE); Markus Linssen, Heilbronn (DE); Maximilian Vogt, Muenchen (DE); Stefan Gruenewald, Stuttgart (DE)

(21) Appl. No.: 19/325,142

(22) Filed: Sep. 10, 2025

(30) Foreign Application Priority Data
Sep. 11, 2024 (DE) 10 2024 208 625.8

(51) Int. Cl. B60W 40/08; B60W 50/00; G06N 20/20

(52) U.S. Cl. CPC B60W 40/08; B60W 50/0097; G06N 20/20; B60W 2510/202; B60W 2540/223

(57) ABSTRACT

A computer-implemented method for detecting a change in the driver's state with a steer-by-wire steering system includes (i) recording data of at least one steering parameter from the steer-by-wire steering system over a measurement time, (ii) predicting the at least one steering parameter based on the recorded data for a test time, (iii) recording the at least one steering parameter at test time, and (iv) detecting a change in the driver's state using the predicted steering parameter and the detected at least one steering parameter at the test time.

### BACKGROUND

Semi-autonomous and fully autonomous cars equipped with steer-by-wire steering systems face a number of complex challenges, particularly related to the lack of feedback from the road to the wheels and via the handlebars to the driver. In the traditional mechanical steering system, the torque exerted by the driver on the steering wheel is transmitted directly to the front wheels via mechanical connections and gear wheels. This mechanical connection provides the driver with continuous haptic feedback on the condition of the road, tire grip and the handling of the vehicle. This feedback is essential to ensure vehicle control in various driving situations, for example on slippery roads or uneven lanes.

In steer-by-wire steering systems, on the other hand, the mechanical connecting element is replaced by electrical signals and actuators. The steering wheel is no longer directly connected to the wheels, but communicates via sensors and control units with electric actuators that adjust the steering angle of the wheels. Although this architecture offers advantages in terms of design freedom and the integration of additional driver assistance systems, it leads to a considerable loss of natural haptic feedback.

The lack of direct feedback poses a significant challenge, as the driver is no longer able to obtain information about road conditions and vehicle behavior through the steering wheel. This can lead to a reduced feeling of vehicle control and increased uncertainty in critical driving situations. This is particularly problematic at high speeds or in emergency situations where quick and precise steering maneuvers are required. Without the direct feedback, the driver may have difficulty making the correct steering response, which can increase reaction times and potentially lead to dangerous driving situations.

Another problem arises from the fact that the haptic feedback in the traditional steering system also represents a kind of passive safety. It allows the driver to make unconscious adjustments and perceive subtle signals from the road that indicate potential dangers. This passive safety is lost in the steer-by-wire steering system, which increases the demands on driver assistance systems and sensor technology to fill this gap.

In addition to these challenges, the focus is on recording the driver's state, which plays a particularly important role in semi-autonomous vehicles. The condition of the driver, for example the position of the eyelids, which can indicate fatigue, or whether or not the driver has his hands on the steering wheel, are critical safety factors. Fatigue detection systems that monitor eye movements and eyelid position are technically demanding, but can be realized using advanced cameras and algorithms. However, the detection of the “hands on the steering wheel” status in steer-by-wire steering systems poses a greater problem.

In traditional steering systems, the presence of the hands on the steering wheel can be determined by measuring the applied torque. In contrast, it is difficult to obtain a comparable level of feedback with steer-by-wire steering systems due to the lack of a mechanical connection. As the steering wheel is not directly connected to the wheels, there is no direct resistance, which is used in mechanical systems for torque measurement. Instead, alternative sensors and technologies, such as capacitive touch sensors or pressure sensors, need to be integrated to detect whether the driver is contacting the steering wheel. However, these sensors are often prone to false alarms and can be affected by different environmental conditions and driving practices.

Against this background, the disclosure is based on the task of proposing a method with which the driver's condition can be determined from the available data.

The problem is solved according to the disclosure by the subject-matter of the set forth below.

### SUMMARY

According to a first aspect of the disclosure, this task is solved by a computer-implemented method for detecting a change in the driver's state with a steer-by-wire steering system, wherein the method comprises the steps of:
recording data of at least one steering parameter from the steer-by-wire steering system over a measurement time tₘ;
predicting the at least one steering parameter based on the recorded data for a test time t_{c};
recording the at least one steering parameter at test time t_{c}; and
detecting a change in the driver's state using the predicted steering parameter and the recorded at least one steering parameter at the test time t_{c}.

The steering parameter can basically be a parameter that can be detected by the steer-by-wire steering system. Preferably, these are one or more parameters that are already recorded and used to control the vehicle.

The test time t_{c} lies outside and after the measurement period tₘ.

The basis of the disclosure is that the steering behavior of a driver changes with his condition. Depending on the condition, this change can be strong or weak. The measurement period tₘ should be selected according to the states to be classified. The interval between the end of the measurement period tₘ and the test time t_{c} should also be selected so that the state may have changed during this period or at least the state change can be detected.

A change of state from one state of tiredness to another can take several minutes, for example. In this case, the measurement period tₘ should be sufficiently long and the test time t_{c} sufficiently late. Other changes of state, such as whether the driver uses both hands to steer or not, can be measured at significantly shorter intervals tₘ and at earlier test times t_{c}. A particularly advantageous interval between the end of the measurement period tₘ and the test time t_{c} is between 10 ms and 500 ms, preferably 100 ms.

As a result, the length of the measurement period tₘ and the interval between the measurement period tₘ and the test time t_{c} should be adapted to the states to be classified.

It is also possible to use different lengths of the measurement period tₘ and different distances between the measurement period tₘ and the test time t_{c} for different steering parameters. This makes it possible to take into account the fact that the change in the driver's state has a different effect on different steering parameters.

The data recording of at least one steering parameter can be carried out by a suitable sensor system within the steering system. Depending on whether the steering system classifies the driver's condition itself or not, the data is passed on to a suitable control unit, such as an on-board computer in the vehicle.

At least one steering parameter is predicted for the test time t_{c}. The prediction is based on the recorded data. The prediction projects the state of the driver in the measurement period tₘ into the future. A comparison of the past (from the measurement period tₘ) with the present (at the test time t_{c}) is thus realized by comparing it with the at least one steering parameter recorded at the test time t_{c}. If these values differ sufficiently, there is a detectable change of state.

Preferably, a threshold value is used for the difference between the compared steering parameters. If this is exceeded, this indicates a change in the driver's state. As long as the threshold value is not exceeded, the driver's behavior is within a certain tolerance limit.

If a change in the driver's state is detected, this can have various consequences. The simplest consequence is the display of a warning message so that the driver can react accordingly if the change of state was unintentional. However, more complex control commands or functions can also be activated. For example, the vehicle can switch from manual to semi-autonomous or fully autonomous operation or vice versa, depending on which state is the initial state and which is the target state.

Particularly simple embodiments can distinguish between two states of the driver, i.e. a change from one state to the other and back. In more complex embodiments, the method can be used to distinguish the transitions between several states.

By using data already available from the steering system and the prediction of the steering system, a state of the driver, in particular a change of state, can be detected. This solves the task of the disclosure.

In one embodiment, predicting the at least one steering parameter comprises executing a regression algorithm or a machine learning algorithm to perform a regression.

Regression is a statistical method used to predict a continuous measurement parameter. It models the relationship between a dependent variable (target variable) and one or more independent variables (predictors). The classic regression approach and modern machine learning models each offer different methods and advantages for solving this problem.

A classic regression algorithm, such as linear regression, is based on the assumption that the relationship between the independent variables and the dependent variable is linear. The aim of linear regression is to find a straight line that best describes the data points. Mathematically, this is achieved by minimizing the sum of the squared deviations (errors) between the predicted and actual values. For this method, the least squares method can be used to determine the coefficients of the linear equation that best fits the data. A major advantage of classical linear regression is its simplicity and interpretability. The coefficients directly indicate the influence of the respective predictors on the target variable, which enables a clear and intuitive interpretation of the results. In addition, classic regression models are generally less computationally intensive and require less training data compared to more complex machine learning models.

Machine learning models for regression, such as decision trees, random forests or neural networks, offer a more flexible and powerful alternative to classic regression algorithms. These models can better record non-linear relationships and complex interactions between the predictors. Decision trees, for example, repeatedly segment the data space into subgroups, each of which has a target variable that is as homogeneous as possible, and thus create a tree-like model of the decisions. Random forests extend this idea by training multiple decision trees and averaging their predictions to increase accuracy and robustness. Neural networks, especially deep neural networks, can recognize even more complex patterns and relationships in the data by using multiple layers of nodes (neurons) connected by weighted links and using non-linear activation functions.

The main advantage of machine learning models lies in their ability to model complex and non-linear relationships that classical regression approaches cannot record. These models can process large amounts of training data and adapt themselves in order to achieve optimum prediction accuracy. They are particularly useful in cases where the underlying relationships between the predictors and the outcome variable are complex and not obvious.

However, machine learning models also present challenges. They are often less interpretable than classic regression models, as the relationships between the predictors and the target variable are represented by complex structures and not by simple linear equations. They are also more computationally intensive and often require larger amounts of data for training in order to develop their full potential. This can be a limiting factor, particularly in the context of vehicle control.

Overall, the choice between a classic regression algorithm and a machine learning model depends on the specific requirements and the characteristics of the data and thus the steering parameters used. While classic regression methods offer simplicity and interpretability, machine learning models are characterized by their flexibility and performance in modeling complex patterns.

In one embodiment, detecting the change in the driver's state comprises executing a machine learning algorithm to perform a classification.

Classification is a central application area in machine learning that aims to assign predefined categories or classes to data points.

To begin with, a data set consisting of a plurality of observations is required. Each observation has several characteristics (features) and an assigned class (label). The first step in training a classification model is to prepare the data, which involves cleaning, normalizing and, if necessary, transforming the features to maximize the quality of the input data.

A common machine learning model for classification tasks is the decision tree. Decision trees recursively segment the data space based on the features by making a decision at each node that aims to maximize the homogeneity of the classes in the resulting subsets. These decisions are based on criteria such as information entropy or the Gini index. In mathematical terms, entropy is used to calculate the information gain, which measures how well a particular feature separates classes. The node with the highest information gain is selected as the decision point, and this process is repeated recursively until the leaves of the tree contain classes that are as pure as possible.

Another powerful classification model is neural networks, especially deep neural networks (deep learning). Neural networks consist of several layers of neurons, with each layer performing a non-linear transformation of the input data. These transformations are realized by weight matrices and activation functions such as ReLU (Rectified Linear Unit) or Sigmoid. During the training process, the weights are adjusted by backpropagation, a method that uses gradient descent to minimize the error defined by a loss function (e.g. cross entropy loss for classification problems). The gradient of the loss function with respect to the weights is calculated and the weights are iteratively adjusted in the direction of the negative gradient to increase the prediction accuracy of the model.

Support Vector Machines (SVM) are another popular classification model. An SVM searches for the optimal dividing line (hyperplane) that separates the classes in the feature space. This hyperplane maximizes the distance (margin) between the nearest data points (support vectors) of both classes. The mathematical basis for this is the solution of a convex optimization problem, which is often solved using quadratic programming. For non-linearly separable data, the SVM can apply the so-called kernel trick, which transforms the data into a higher-dimensional space in which linear separation is possible.

After training, the model is validated and tested to evaluate its performance. Metrics such as accuracy, precision, recall and F1 score are used, which are calculated on a test set that the model has not seen during training. These metrics provide insight into the model's ability to perform correct classifications and minimize errors.

The choice of model and methodology depends heavily on the specific characteristics of the data and the classification task to be solved, i.e. the possible states of the driver to be recognized.

In one embodiment, predicting the at least one steering parameter and/or detecting the change in the driver's state comprises executing an explainable boosting machine.

The classification of a behavior with an Explainable Boosting Machine (EBM) combines the advantages of Generalized Additive Models (GAMs) and modern boosting techniques to create a powerful and at the same time interpretable machine learning model. An EBM aims to combine the advantages of the high predictive accuracy of boosting models with the transparency and comprehensibility of GAMs.

An EBM is a special type of GAM in which the modeling is improved by iterative boosting. Classical GAMs represent the relationship between the input characteristics and the target variable as a sum of univariate functions, each of which depends on only one feature.

In an EBM, this approach is expanded and optimized using a sequential training method. A gradient boosting algorithm is used to learn univariate functions. The boosting process takes place in steps, in which the model is updated in each step in order to reduce the errors of the previous steps. The algorithm starts with a simple model, e.g. a constant prediction, and iteratively improves this model by adding small, adaptable steps that improve the prediction.

In each boosting step, a new function is added that minimizes the difference (the so-called residual) between the current prediction and the actual values. This function is adapted to the error by the gradient descent so that the model learns to correct the errors systematically. The resulting functions are therefore optimized to precisely map the relationship between each feature and the target variable.

A major advantage of EBMs over traditional boosting algorithms such as gradient boosting machines (GBMs) or random forests is their interpretability. While GBMs are often considered black box models because they model complex non-linear relationships in the data, the additive structure of EBM provides a clear and understandable representation of the influencing factors. Each feature can be visualized and analyzed individually, providing insight into the impact of individual features on predictions.

Another advantage of EBMs is their robustness and flexibility. The boosting process ensures that the model adapts well to the data and that overfitting is minimized. Due to the iterative nature of the training process, the model can be continuously improved until an optimum level of prediction accuracy is achieved. In addition, the additive structure of EBM enables simpler regularization, which further reduces the risk of over-adjustment.

In one embodiment, the detection of the change in the driver's state is used to determine whether the driver is holding the steering wheel or not.

In this embodiment, the method only needs to differentiate between two states or changes of state. This makes the method particularly simple.

To detect a change of state, it must be known how the at least one steering parameter behaves in at least one of the two states. The other state need not be known, provided that a sufficient limit is known above which the first state is no longer classified. In general, this would not distinguish between state A and state B, but between state A and state not-A, where not-A represents a larger quantity than a defined state B. In this specific case, this means that a distinction can be made between the states “both hands on the steering wheel” and “both hands not on the steering wheel.” For the method, it is therefore only necessary to know how at least one steering parameter behaves when the driver holds the steering wheel with both hands. All other possibilities, such as holding with only one hand, with a loose grip or in the wrong position, can be recognized collectively as “both hands not on the steering wheel”. The method thus detects whether the driver changes their holding position, in particular whether they loosen, move or tighten the handle.

In one embodiment, the prediction error of the at least one steering parameter and/or the measurement error when recording the data of the at least one steering parameter are taken into account when detecting the change in the driver's state.

There is always a certain degree of inaccuracy when recording parameters. If the parameters are processed further, their measurement error is also propagated. The error is essentially determined by the choice of measuring method or measuring device. However, errors can also occur in predictions. For example, the model used to predict the at least one steering parameter may comprise a physical model or a simulation, which are also subject to errors. These measurement and prediction errors can be taken into account when detecting a change of state, which increases the detection precision.

In one embodiment, the at least one steering parameter is predicted iteratively from the end of the measurement time tₘ up to the test time t_{c}.

In this embodiment, the at least one steering parameter is predicted several times up to the test time t_{c} one after the other. If the test time is 100 ms after the end of the measurement period tₘ for example, the at least one steering parameter can be predicted in smaller but more precise steps, in particular in 10 ms steps. When predicting the next step, the previous step can also be used so that the number of available data points increases with each step. This increases the precision of the prediction.

In one embodiment, the at least one steering parameter comprises the rotor angle, the rotor speed, the rotor acceleration and/or the torque of a steering wheel actuator.

Rotor angle, rotor speed, rotor acceleration and/or the torque of the steering wheel actuator are steering parameters that can be determined particularly easily, as they are recorded anyway for the control of the steer-by-wire steering system. Furthermore, the errors of these measured variables can be used to predict the at least one steering parameter and/or to detect the change in the driver's state.

In a further consideration, the disclosure relates to a computer program having a program code for performing a method as described above when the computer program is executed on a computer.

In a further consideration, the disclosure relates to a computer readable disk having a program code of a computer program for performing a method as described above when the computer program is executed on a computer.

In a further aspect, the disclosure relates to a steer-by-wire steering system for a motor vehicle, wherein the steer-by-wire steering system comprises a control device for detecting a change in the driver's state, wherein the control device is designed to record data of at least one steering parameter over a measurement time tₘ, to predict the at least one steering parameter for a test time t_{c}, to record the at least one steering parameter at the test time t_{c}, and to detect a change in the driver's state based on the predicted at least one steering parameter and the at least one steering parameter recorded at the time t_{c}.

A control device for a steer-by-wire steering system for detecting a change in the driver's state, wherein the system comprises:
means for receiving data of at least one steering parameter from the steer-by-wire steering system and means for buffering the received data;
means for predicting the at least one steering parameter for a test time t_{c}; and
means for detecting a change in the driver's state from the predicted at least one steering parameter and a data point of the at least one steering parameter recorded at the test time t_{c}.

In summary, the present disclosure discloses a computer-implemented method for detecting a change in the driver's state a computer program, a computer-readable data carrier, a steer-by-wire steering system and a control device for a steer-by-wire steering system.

The described embodiments and refinements may be combined with one another as desired.

Further possible designs, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

The figures show:

FIG. 1 schematically, the detection of a change in the driver's state according to one embodiment;

FIG. 2 schematically, a further embodiment of the method for detecting a change in the driver's state; and

FIG. 3 schematically, the sequence of the method according to one embodiment.

### DETAILED DESCRIPTION

In the figures of the drawings, identical reference numbers denote identical or functionally identical elements, parts or components, unless stated otherwise.

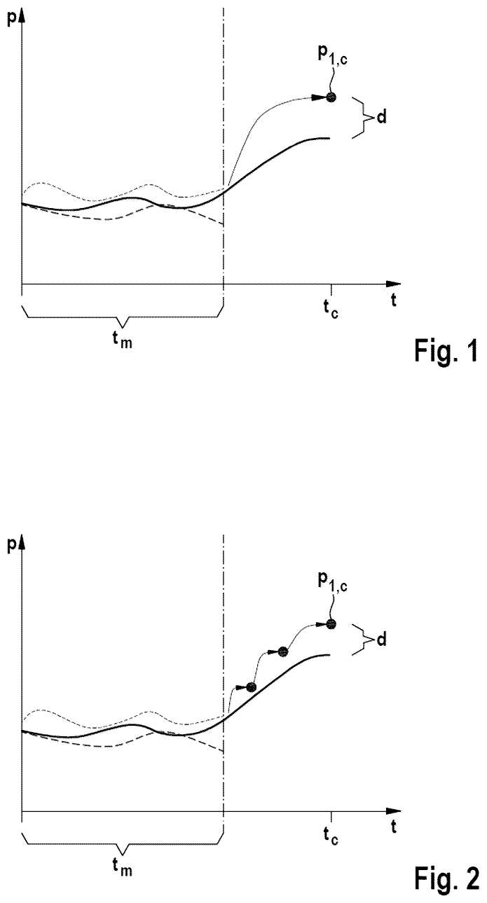

FIG. 1 shows a diagram that schematically illustrates the detection of a change in the driver's state.

In the time period tₘ three steering parameters p₁ (solid line), p₂ (dashed line) and p₃ (dotted line) are recorded by the steer-by-wire steering system. From the end of the measurement period tₘ the recorded parameters no longer play a role in the prediction of at least one steering parameter at time t_{c}. Nevertheless, the prediction for further, later test times can run in parallel so that the steering parameters p₁, p₂, p₃ can be recorded continuously.

In this embodiment, only the steering parameter p₁ is used to detect the change in state. However, the other steering parameters p₂ and p₃ can be used to predict the steering parameter p₁. In this embodiment, the prediction of the steering parameter p_{1,c} is determined in one step.

The prediction of the steering parameter p_{1,c} and the steering parameter p₁ recorded at the test time t_{c} are compared with each other. For example, the difference d can be determined, from which the existence of a change of state is then determined.

The method shown in FIG. 2 differs from that in FIG. 1 in that the predicted steering parameter p_{1,c} is determined using two preliminary stages. The preliminary stages can also be used to predict the steering parameter p_{1,c}.

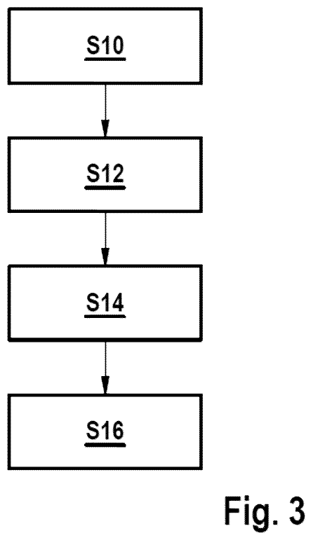

FIG. 3 is a schematic illustration of an embodiment of the method described above.

In step S10, data of at least one steering parameter of a steer-by-wire steering system is recorded. In this step, more parameters can be recorded than are required later for the actual detection.

In step S12, at least one of the steering parameters is predicted for a test time t_{c}. Furthermore, in step S14 at the test time t_{c} the at least one steering parameter is determined again.

In the final step S16, the prediction and the at least one steering parameter recorded at the test time t_{c} are used to detect whether the driver's state has changed.

What is claimed is:

1. A computer-implemented method for detecting a change in a driver's state with a steer-by-wire steering system, comprising:
recording data of at least one steering parameter from the steer-by-wire steering system over a measurement time;
predicting the at least one steering parameter based on the recorded data for a test time;
recording the at least one steering parameter at test time; and
detecting a change in the driver's state using the predicted steering parameter and the recorded at least one steering parameter at the test time.

2. The method according to claim 1, wherein predicting the at least one steering parameter comprises executing a regression algorithm or a machine learning algorithm to perform a regression.

3. The method according to claim 1, wherein detecting the change in the driver's state comprises executing a machine learning algorithm to perform a classification.

4. The method according to claim 2, wherein predicting the at least one steering parameter and/or detecting the change in the driver's state comprises executing an explainable boosting machine.

5. The method according to claim 1, wherein the detection of the change in the driver's state is used to determine whether or not the driver is holding the steering wheel.

6. The method according to claim 1, wherein, when detecting the change in the driver's state, the prediction error of the at least one steering parameter and/or the measurement error when recording the data of the at least one steering parameter are taken into account.

7. The method according to claim 1, wherein the prediction of the at least one steering parameter is made iteratively from the end of the measurement time up to the test time.

8. The method according to claim 1, wherein the at least one steering parameter comprises the rotor angle, the rotor speed, the rotor acceleration and/or the torque of a steering wheel actuator.

9. A computer program having program code for performing the method according to claim 1 when the computer program is executed on a computer.

10. A computer-readable data carrier having program code of a computer program for performing the method according to claim 1 when the computer program is executed on a computer.

11. A steer-by-wire steering system for a motor vehicle, wherein the steer-by-wire steering system comprises a control device for detecting a change in the driver's state, and wherein the control device is designed to record data of at least one steering parameter over a measurement time to predict the at least one steering parameter for a test time, to record the at least one steering parameter at the test time, and to detect a change in the driver's state based on the predicted at least one steering parameter and the at least one steering parameter recorded at the time.

12. A control device for a steer-by-wire steering system for detecting a change in a driver's state, wherein the system comprises:
means for receiving data of at least one steering parameter from the steer-by-wire steering system and means for buffering the received data;
means for predicting the at least one steering parameter for a test time; and
means for detecting a change in the driver's state from the predicted at least one steering parameter and a data point of the at least one steering parameter recorded at the test time.
